(19) United States
(12) Patent Application Publication
(10) Pub. No.: US 2013/0083407 A1
(43) Pub. Date: Apr. 4, 2013

(54) OPTICAL STRUCTURES FORMED WITH THERMAL RAMPS

(71) Applicant: Reflexite Corporation, Avon, CT (US)

(72) Inventors: Douglas H. AXTELL, Rochester, NY (US); Scott W. WILT, North Chili, NY (US)

(73) Assignee: REFLEXITE CORPORATION, Avon, CT (US)

(21) Appl. No.: 13/628,969

(22) Filed: Sep. 27, 2012

Related U.S. Application Data
(60) Provisional application No. 61/540,308, filed on Sep. 28, 2011.

(51) Int. Cl. G02B 3/08; B29D 11/00; B05D 5/06

(52) U.S. Cl. CPC G02B 3/08; B05D 5/06; B29D 11/00269
USPC 359/742; 427/162; 264/1.7

(57) ABSTRACT

This technology relates generally to a method of making an optical device. The method involves providing a glass carrier having a first surface, forming an optic structure in an at least partially transmissive layer, wherein the at least partially transmissive layer is adjacent the first surface of the glass carrier, and curing the at least partially transmissive layer using a thermal ramp up to a cure temperature at or within about 10° C. of an operating temperature of the optical device. This technology also relates to the resulting optical device and a system including an array of optical devices described herein and an array of photovoltaic cells configured with respect to the array of optical devices to convert light energy passing through the array of optical devices into electricity.

This application claims the benefit of U.S. Provisional Patent Application Ser. No. 61/540,308, filed Sep. 28, 2011, which is hereby incorporated by reference in its entirety

### FIELD

This technology relates generally to optical structures, methods of making them, and uses thereof. In particular, this technology relates to optical structures, such as silicone-on-glass optical structures, formed using thermal ramps.

### BACKGROUND

Improving the efficiency of solar cells is critical for increased deployment and the subsequent reduction of greenhouse gas emissions. This issue has become even more urgent as countries seek clean alternative energy sources. However, this must be accomplished at a competitive cost with respect to other energy sources. One solution gaining momentum is the branch of solar power known as concentrator photovoltaics (CPV) and concentrated solar power (CSP), where the cost reduction is derived from replacing expensive photovoltaic (PV) cell material with lower cost optical systems. A typical CPV apparatus includes a lens array positioned to focus solar energy onto a corresponding array of photovoltaic cells for the generation of electricity. Typically, the lens used to concentrate the solar light onto the photocell is a Fresnel lens comprising a superstrate or carrier and a Fresnel optical structure. The Fresnel optical structure includes a multitude of prism facets at prescribed angles.

Silicone-on-glass (SOG) primary optics are one option for use in CPVs and in CSP arrays. In an SOG optic, the Fresnel lens is a hybrid made out of glass as a carrier and a silicone layer (or other flexible highly transmissive and UV stable polymers) with the Fresnel structure cast onto the underside or side toward the photocell. Thus, in these SOG primary optics, the glass carrier is exposed to the weather side while a microstructured Fresnel lens made of silicone is on the inside surface of the primary optic, where it is protected from exposure to the elements. These SOG CPVs or CSPs are useful in solar panels/modules, as they require only a very thin silicone layer and are very durable, exhibiting resistance to water, extreme temperatures, and other environmental factors.

The Fresnel lens is manufactured by thermally curing the silicone at an elevated temperature. Since manufacturing efficiency increases with shorter cycle times and increased cure rates are one way to provide the shorter cure times required, running process temperatures during curing at their highest practical setting is one path to lower manufacturing costs. However, the use of high cure temperatures can result in some expansion or contraction in the optic structure during use with a corresponding reduction in efficiency. Moreover, when using high cure temperatures, the silicone cures quickly with the viscosity rising past a million poise within a few seconds of initiating the cure. This results in a change in shape of the facets in the silicone-on-glass lens; in particular, the formation of a curved surface rather than the straight facet of the mold (facet rounding). In addition, material voids are often produced during manufacture under these conditions. These shape changes and material voids cause the Fresnel lens performance to deviate from optimum leading to losses in optical efficiency.

As such, there is a need for a method of making a lens that compensates for the deviations from the optical design incurred as a result of the typical manufacturing and curing processes. There is also a need to provide a lens that does not suffer from the performance degradation of the prior art. This technology is directed to overcoming these and other deficiencies in the prior art.

### SUMMARY

This technology relates to a method for forming an optical device comprising providing a glass carrier having a first surface, forming an optic structure in an at least partially transmissive layer, wherein the at least partially transmissive layer is adjacent the first surface of the glass carrier, and curing the at least partially transmissive layer using a thermal ramp up to a cure temperature at or within about 10° C. of an operating temperature of the optical device.

This technology also relates to an optical device comprising a glass carrier having a first surface and an at least partially transmissive layer adjacent the first surface of the glass carrier, wherein the at least partially transmissive layer forms an optic structure and is cured using a thermal ramp up to a cure temperature at or within about 10° C. of an operating temperature of the optical device.

This technology further relates to a system including an array of optical devices described herein and an array of photovoltaic cells configured with respect to the array of optical devices to convert light energy passing through the array of optical devices into electricity.

This technology can be used to lower manufacturing costs, and increase the amount of product that can be manufactured in a period of time without additional capital expenditures, while maintaining the facet geometry and fidelity of the optic. In addition, this invention can be used in many applications, such as those requiring high heat (e.g., stage lighting) where traditional plastic lenses will not suffice.

### BRIEF DESCRIPTION OF THE DRAWINGS

FIG. 1 is a graph showing the bivariate fit of cure time (min) by cure temperature (° C.) for a silicone optic structure of this technology;

FIG. 2 is a graph showing a thermal ramp for an optical device of this technology;

FIG. 3 is a schematic of an optical device in accordance with one embodiment of the present technology; and

FIG. 4 is a cross-sectional view of an optical device in accordance with one embodiment of the present technology.

### DETAILED DESCRIPTION

This technology relates to a method for forming an optical device comprising providing a glass carrier having a first surface, forming an optic structure in an at least partially transmissive layer, wherein the at least partially transmissive layer is adjacent the first surface of the glass carrier, and curing the at least partially transmissive layer using a thermal ramp up to a cure temperature at or within about 10° C. of an operating temperature of the optical device.

The glass carrier provides a superstrate or carrier for the at least partially transmissive layer, although other materials may be applied to the glass carrier.

In one exemplary embodiment, the glass carrier has a thickness of from about 2.0 mm to about 6.0 mm. In another embodiment, the refractive index of the glass carrier is between about 1.515 and about 1.519. In a further embodiment, the glass carrier is a low iron float glass with less than about 0.4% iron content. In yet another embodiment, the glass carrier is partially heat strengthened per TVG DIN EN 1863, A2.

A material is selected to be formed on the glass carrier to provide the at least partially transmissive layer of the optical device. As used herein, the term “at least partially transmissive” means a material which at least partially allows the transmission of light therethrough. In one embodiment, the at least partially transmissive layer is highly transmissive allowing substantially all light from a particular light source to pass therethrough. The light source can be any suitable light source including, but not limited to, sunlight, lamplight, and artificial light.

In one exemplary embodiment, the material selected for the at least partially transmissive layer is silicone (e.g., optical grade silicones), although other materials, such as flexible, highly transmissive, and UV stable polymers, may be used. The silicone can be an addition cure silicone or a condensation cure silicone. Suitable at least partially transmissive layers include, but are not limited to, NuSil R-2615, Dow Corning Sylgard 184 or equivalents, Quantum Silicones QM 264 or equivalents, customized silicones such as Loctite 5033 Nuva-Sil Silicone, single component optically clear silicones, and optically clear pressure sensitive adhesives.

In one embodiment, the silicone is a platinum cure silicone, also referred to as a platinum catalyzed silicone. Platinum cure silicones are useful, for example, when higher operating temperatures are required. Suitable examples of platinum cure silicones include, but are not limited to, NuSil R-2615, Shin Etsu KE-109, and Momentive RTV 615.

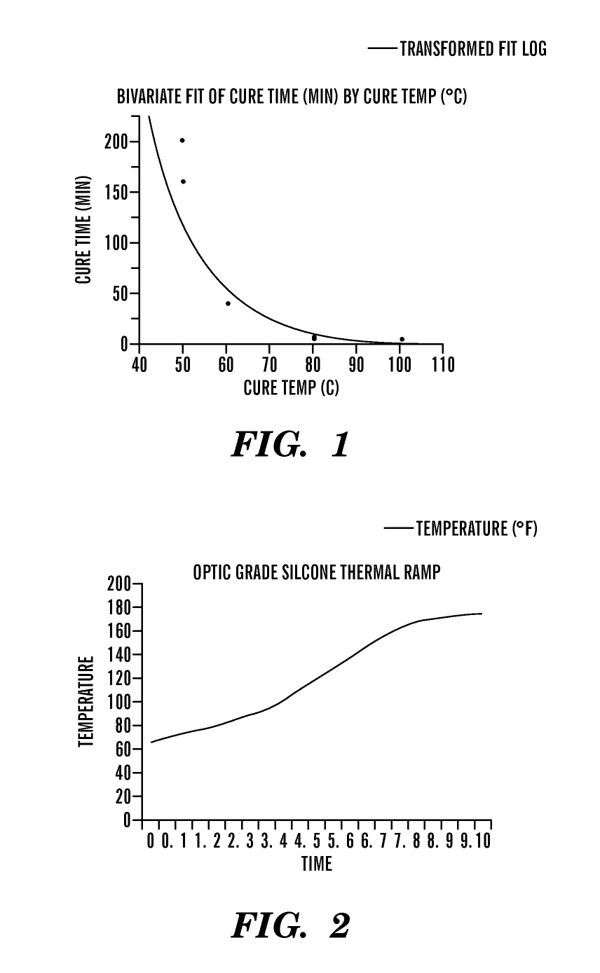

Silicones can be cured between room temperature and temperatures up to 200° C., with the cure rate increasing in proportion with the cure temperature (see FIG. 1). With many platinum and condensation cure silicones, the cure rate is best expressed as a logarithmic relationship.

In another embodiment, the at least partially transmissive layer has a high optical transmission, such as from 88% to 95% between 350 nm and 1100 nm.

In yet another embodiment, the at least partially transmissive layer has a refractive index tailored to optimize the optical design. Such refractive index values are determined by the optical design but may include, for example, low outgassing silicones with refractive indices between 1.35 and 1.57.

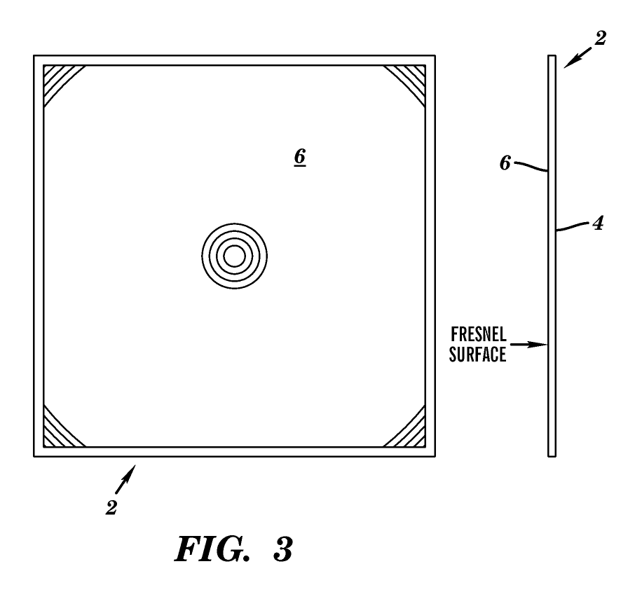

The optic structure formed in the at least partially transmissive layer may be, for example, a diffuser, a light guide, or a lens, such as a Fresnel lens comprising multitudes of prism facets, including one or more slope facets coupled together by one or more draft facets as shown, for example, in FIG. 3. With this technology, high performance, optimized lenses are produced which compensate for high cure temperatures and cure rates which cause changes in dimension or facet rounding.

In one embodiment, the facet angles of the Fresnel lens are designed such that a minimal spot diameter is achieved at a nominal focal length for one wavelength of light. Shorter and longer wavelengths will have a larger diameter at this nominal focal distance (having minimal spot diameters located above and below this nominal distance). Secondary optical elements (SOE) may be utilized to improve the concentration of the shorter and longer wavelengths of light. In another embodiment, the Fresnel lens includes a multi-focus approach. Multiple groove bands are used to focus a set of specific wavelengths. A set of adjacent facets may be associated with a specific set of wavelengths, with each prism shape crafted to focus an associated wavelength. This design method can direct light nominally to a photovoltaic cell location or to the SOE acceptance area in a CPV.

In accordance with this technology, the optic structure can be formed, for example, by compression molding, injection molding, or casting a polymer on the glass carrier. In one embodiment, forming an optic structure comprises at least partially filling an optic mold with the at least partially transmissive material. Techniques for forming an optic structure including one or more slope facets coupled together by one or more draft facets are known in the art and are described, for example, in U.S. Pat. No. 4,170,616, which is hereby incorporated by reference in its entirety. Suitable techniques include coating a tool with a layer of at least partially transmissive material and then impressing a nickel tool having the desired design into the at least partially transmissive material layer and completing curing.

In accordance with the present technology, the at least partially transmissive layer is cured using a thermal ramp. As used herein, a thermal ramp is a thermal profile which includes exposing the at least partially transmissive layer for a first period of time to a first temperature below the cure temperature of the at least partially transmissive layer and then raising the temperature to a targeted elevated cure temperature for a second period of time.

In particular, the at least partially transmissive layer can be placed into an optic mold at a temperature which delays cure until the mold is filled completely. Then the temperature can be raised at a controlled rate to the targeted elevated cure temperature. The first and second periods of time and the rate of temperature increase are determined by the at least partially transmissive material used, with the first period of time sufficient to ensure that the mold is filled while the viscosity of the at least partially transmissive layer is at its lowest point and the second period of time sufficient to allow the at least partially transmissive layer to crosslink. In one embodiment, the temperature is raised as quickly as possible to the targeted elevated cure temperature.

Since manufacturing efficiency increases with shorter cycle times and increased cure rates are one way to provide the shorter cure times required, running process temperatures during curing at their highest practical setting is one path to lower manufacturing costs. However, in accordance with the present technology, the optical efficiency of the optical device (e.g., lens) is greatest if cured at a temperature close to the working temperature of the final assembly because the facet fidelity matches the optical design. If the cure temperature and working temperature of the lens deviate significantly, this can result in some expansion or contraction in the optic structure with a corresponding reduction in efficiency.

In accordance with this technology, the targeted elevated cure temperature is a temperature at or within about 10° C. of the expected operating temperature of the final optic. In one embodiment, the targeted elevated cure temperature is within about 5° C. or within about 2° C. of the expected operating temperature of the final optic. In another embodiment, the targeted elevated cure temperature is at the expected operating temperature of the final optic. In yet another embodiment, the expected operating temperature of the final optic is the expected peak operating temperature of the final optic.

Additionally, as the cure rate increases, the time to fully fill or pack out the optical mold decreases with an associated loss in optical efficiency correlated to facet rounding and material voids. Further, as a platinum cure silicone cures, the viscosity increases thus increasing the amount of pressure required to fill an optic mold completely.

Using a thermal ramp during the cure in accordance with the method of this technology allows the use of lower pressure during the initial stages of the cure with excellent optic fidelity due to the lower viscosity of the at least partially transmissive layer during the critical part of the process when the optic mold is being filled. Without using a thermal ramp during the cure, the at least partially transmissive layer cures quickly with the viscosity rising significantly within a few seconds of initiating the cure. This results in optic structures with some facet rounding if the optic working conditions dictate a high cure temperature.

In accordance with this technology, using a thermal ramp during the cure step keeps the at least partially transmissive layer at a low viscosity level while the optic mold is filled so as to provide the best possible fidelity for a period of time determined empirically or using modeling and experimentation.

In one embodiment, the temperature is increased at a controlled and predetermined rate to a temperature at or within 10° C. of the expected operating temperature of the final optic, or, if lower, the maximum cure temperature recommended by the manufacturer of the at least partially transmissive layer. The at least partially transmissive layer is held at this second setpoint temperature, or targeted elevated cure temperature, for a period of time until the material has fully cross-linked. At this point, the optic is removed from the mold (tooling). If necessary, further annealing can be performed after the optic is removed from the tooling in a secondary process.

Other possible post processing steps include, but are not limited to, applying thin-film coatings via chemical vapor deposition (CVD), physical vapor deposition (PVD), or other deposition processes.

One example of a thermal ramp in accordance with the present technology is shown in FIG. 2, which is an exemplary thermal ramp for an optic grade silicone.

This technology also relates to an optical device comprising a glass carrier having a first surface and an at least partially transmissive layer adjacent the first surface of the glass carrier, wherein the at least partially transmissive layer forms an optic structure and is cured using a thermal ramp up to a cure temperature at or within about 10° C. of an operating temperature of the optical device.

In a further embodiment, the optic structure is a diffuser, a light guide, or a lens, such as a Fresnel lens. An example of an optical device in accordance with one embodiment of the present invention is shown in FIG. 3. Referring to FIG. 3, an optical device 2 including a glass carrier 4 is shown. An at least partially transmissive layer 6 is adjacent a first surface of the glass carrier 4. In this embodiment, the at least partially transmissive layer 6 forms a Fresnel lens.

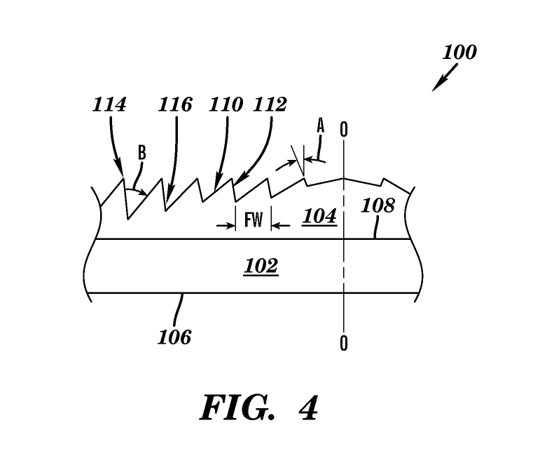

Referring to FIG. 4, a lens 100 made in accordance with one embodiment of this technology is illustrated. The lens 100 includes a glass carrier 102 and an at least partially transmissive layer 104. The glass carrier 102 has a first surface 106 and a second surface 108. In one embodiment, the first surface 106 of the glass carrier 102 is exposed to the weather when used in a CPV.

Suitable dimensions and properties for the glass carrier 102 are described above.

Referring to FIG. 4, the at least partially transmissive layer 104 is adjacent the second surface 108. As used herein, the term “adjacent” means that the glass carrier and at least partially transmissive layer may or may not be in contact, but there is the absence of anything of the same kind in between. In the embodiment shown in FIG. 4 the at least partially transmissive layer 104 is adjacent and in contact with the second surface 108.

In one exemplary embodiment, the at least partially transmissive layer is a silicone layer. Suitable at least partially transmissive layers are described above. In one exemplary embodiment, the at least partially transmissive layer 104 has a thickness of from about 0.1 mm to about 2.0 mm. In another embodiment, the refractive index of the at least partially transmissive layer 104 is between about 1.405 and about 1.420 when measured at the sodium D-line with 589 nanometer wavelength and 21° C.

The at least partially transmissive layer 104 includes one or more slope facets 110 coupled together by one or more draft (or relief) facets 112. The slope and draft facets 110, 112 form facet peaks 114 and facet valleys 116. Referring to FIG. 4, the facet angle B and draft angle A, as well as the facet width or pitch FW and optical axis O are shown. The particular dimensions of the slope and draft facets 110, 112 and the resulting facet angle, draft angle, and pitch are determined based on the intended use and properties of the lens. The angles of the facets typically are from zero or parallel to the surface up to a maximum of approximately 42 degrees from the surface. The height of the facets can be constant or variable and range typically from about 0.1 mm to about 1.0 mm based on the optical design. Typical pitch or facet spacing can be constant or variable and range from about 0.2 mm to about 0.9 mm.

In the embodiment shown in FIG. 4, the at least partially transmissive layer with one or more slope facets coupled together by one or more draft facets forms a Fresnel lens.

The optical device of this technology may be, for example, an SOG primary optic, including a glass carrier and a microstructured Fresnel lens made of addition cure or condensation cure silicone on the inside surface of the primary optic, where it can protected from exposure to the elements.

A further aspect of this technology relates to a system including an array of optical devices of any of the embodiments described herein and an array of photovoltaic cells configured with respect to the array of optical devices to convert light energy passing through the array of optical devices into electricity.

In one embodiment, the system is a CPV apparatus. To further optimize the design of the lens given the full-solar spectrum and the uniformity needed at the photovoltaic cell, SOEs and reflectors also can be incorporated into the CPV apparatus.

As discussed above, various techniques can be employed to focus the solar wavelengths onto a photovoltaic cell with a Fresnel lens. This exemplary technology enables those various techniques to be optimized to yield maximum efficiency of the photovoltaic cell. If a spot-focus Fresnel lens is used, light from the design wavelength will have a minimum beam diameter on the photovoltaic cell. The location of the photovoltaic cell could be adjusted higher or lower to defocus the spot and achieve a more uniform irradiance and thus increase the cell efficiency. Naturally, the lower and higher wavelengths will not focus to the same diameter and must be balanced as a trade-off based on the characteristics of the photovoltaic cell or alternatively can be recovered using an additional collection optic or SOE. Typical embodiments of SOEs include glass TIR reflectors or metallic based reflectors placed directly above the photovoltaic cell.

CPV apparatuses may or may not utilize a SOE. Some advantages of an SOE include increased tolerance to tracking error, improved irradiance uniformity on the photovoltaic cell, improved efficiency over a broad spectral range, increased concentration ratio, and improved allowance for assembly tolerances. On the other hand, the addition of a SOE increases the cost of the apparatus, adds to the assembly complexity and increases the number of possible failure modes.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for forming an optical device comprising:
providing a glass carrier having a first surface;
forming an optic structure in an at least partially transmissive layer, wherein the at least partially transmissive layer is adjacent the first surface of the glass carrier; and
curing the at least partially transmissive layer using a thermal ramp up to a cure temperature at or within about 10° C. of an operating temperature of the optical device.

2. The method according to claim 1, wherein the at least partially transmissive layer is a silicone.

3. The method according to claim 2, wherein the silicone is a platinum cure silicone.

4. The method according to claim 1, wherein the at least partially transmissive layer has an optical transmission of from about 88% to about 95% between 350 nm and 1100 nm.

5. The method according to claim 1, wherein the at least partially transmissive layer has a refractive index of from about 1.39 to about 1.59.

6. The method according to claim 1, wherein the optic structure is a lens.

7. The method according to claim 6, wherein the lens is a Fresnel lens.

8. The method according to claim 1, wherein forming an optic structure comprises at least partially filling an optic mold with the at least partially transmissive material.

9. The method according to claim 1, wherein the thermal ramp comprises exposing the at least partially transmissive layer for a first period of time to a first temperature below a cure temperature of the at least partially transmissive layer and raising the temperature to the cure temperature at or within about 10° C. of an operating temperature of the optical device for a second period of time.

10. The method according to claim 1, wherein the cure temperature is within about 5° C. of an operating temperature of the optical device.

11. The method according to claim 1 further comprising annealing the cured optic structure.

12. The method according to claim 1 further comprising applying a thin film coating to the optical device.

13. An optical device comprising:
a glass carrier having a first surface, and
an at least partially transmissive layer adjacent the first surface of the glass carrier, wherein the at least partially transmissive layer forms an optic structure and is cured using a thermal ramp up to a cure temperature at or within about 10° C. of an operating temperature of the optical device.

14. The optical device according to claim 13, wherein the at least partially transmissive layer is a silicone.

15. The optical device according to claim 14, wherein the silicone is a platinum cure silicone.

16. The optical device according to claim 13, wherein the at least partially transmissive layer has an optical transmission of from about 88% to about 95% between 350 nm and 1100 nm.

17. The optical device according to claim 13, wherein the at least partially transmissive layer has a refractive index of from about 1.39 to about 1.59.

18. The optical device according to claim 13, wherein the optic structure is a lens.

19. The optical device according to claim 18, wherein the lens is a Fresnel lens.

20. A system comprising:
an array of optical devices according to claim 13; and
an array of photovoltaic cells configured with respect to the array of optical devices to convert light energy passing through the array of optical devices into electricity.
